(19) United States
(12) Patent Application Publication
(10) Pub. No.: US 2013/0126432 A1
(43) Pub. Date: May 23, 2013

(54) ORGANOPHILIC POLYSILSESQUIOXANE MEMBRANES FOR SOLVENT NANOFILTRATION AND PERVAPORATION

(71) Applicants: Robert Kreiter, Alkmaar (NL); Goulven Gildas Paradis, Alkmaar (NL); Jaap Ferdinand Vente, Alkmaar (NL); Hessel Lennart Castricum, Amsterdam (NL); Johan Evert Ten Elshof, Enschede (NL)

(72) Inventors: Robert Kreiter, Alkmaar (NL); Goulven Gildas Paradis, Alkmaar (NL); Jaap Ferdinand Vente, Alkmaar (NL); Hessel Lennart Castricum, Amsterdam (NL); Johan Evert Ten Elshof, Enschede (NL)

(73) Assignee: Stichting Energieonderzoek Centrum Nederland, Petten (NL)

(21) Appl. No.: 13/698,262

(22) PCT Filed: May 16, 2011
(86) PCT No.: PCT/NL2011/050333

§ 371 Date: Feb. 4, 2013

(30) Foreign Application Priority Data
May 17, 2010 (NL) 2004724

(51) Int. Cl. B01D 71/70

(52) U.S. Cl. CPC B01D 71/70
USPC 210/640; 210/500.27; 210/321.6; 210/259

(57) ABSTRACT

Selective retaining a relatively hydrophilic molecule from a mixture of a relatively hydrophobic molecule and the relatively hydrophilic molecule can be achieved using a hydrophobic, microporous hybrid membrane based on silica, wherein at least 25% of the silicon atoms is bound to a bridging C₁-C₁₂-hyrdocarbylene group. The average number of carbon atoms of the bridging groups and any additional monovalent organic groups, taken together, is at least 3.5. The membrane can be part of a production facility for separating alcohol/water mixtures.

The invention relates to microporous organophilic organic-inorganic hybrid membranes suitable for liquid or vapour separations and to a process for producing such membranes.

### BACKGROUND

Membranes that have preference for permeation of organic or the more hydrophobic components of a mixture are required for several industrial applications. Two important process types that need such organophilic membranes are solvent-resistant nanofiltration and organophilic pervaporation. Both process types are described in more detail hereafter.

Solvent-resistant nanofiltration, also called organic nanofiltration (ONF), is a promising technology for recovery of valuable components or contaminants from solvent streams, with applications in the food, pharmaceutical, chemical, and biochemical industry. ONF is defined as a pressure-driven filtration process in which the continuous phase consisting of an organic solvent (mixture) permeates through the membranes and another larger molecular species is retained. This larger molecular species can be a macromolecule, catalyst complex, oligomer, inorganic particle, or similar species.

Typical industrial applications of nanofiltration membranes are described below as examples. A detailed overview of possible applications can be found in the overview of Vandezande et al. (Vandezande, Chem. Soc. Rev. 2008, 37, 365-405). Precious metal catalysts with expensive ligand systems can be recovered by permeating solvent, product, and reactants through the ONF membrane. The catalyst is retained in a concentrated stream or recycled to the reactor in a continuous process. This process option allows for continuous operation of otherwise batch reactions. Moreover ONF membranes replace a thermal separation step. Another application is treatment of crude oil or fuel. Fuel streams contain impurities that have a negative effect on engine life times. Cleaning these fuels from particles, metals, and larger molecular species affords a higher quality fuel. ONF membranes can be used to permeate the liquid organics of the fuel while retaining the impurities. Highly viscous hydrocarbons can be separated from higher-value low-viscosity hydrocarbons by ONF. This separation type includes dewaxing of oil, which replaces a thermal separation process involving a cooling step, precipitation step, and solvent evaporation. ONF membrane processes can be used to simplify downstream processes, by selective removal of compounds from hydrocarbons. This removes the need for several process steps, as it potentially replaces solvent-solvent extraction, scrubbing, or thermal separation processes. In general, several industrial solvent streams are lightly contaminated with higher molecular weight species such as organic molecules or particles. Separating these using NF membranes is an alternative for thermal separations.

Common nanofiltration membranes consist of layered or asymmetric polymer films. The transport of organic solvents is governed by dissolution and diffusion phenomena in these essentially dense membranes. The polymeric top layer of such membranes does not resist a large range of organic solvents because of swelling or dissolution in the organic solvent (Vandezande, Chem. Soc. Rev. 2008, 37, 365-405). In these membranes, the selective top layer is the weakest link, as swelling of this layer has a strong influence on the separation performance of the membrane. Specific solvent-membrane combinations are successfully applied. Still, no material can be applied over a broad range of solvents and the separation behaviour of the membrane (selectivity or cut-off) is largely determined by the swelling of the polymer in the mixture.

On the other hand, ceramic nanofiltration membranes are stable in a wide range of organic solvents. In such materials the porous structure with pore sizes below 5 nm is responsible for the separation behaviour. Unfortunately, ceramic membranes (which consist of metal oxides) suffer from poor permeability for organics, due to their hydrophilic nature. This is an intrinsic property of ceramic oxide materials. One of the approaches to improve solvent permeance is hydrophobisation of the ceramic material with organosilanes such as chlorotrimethylsilane (WO 2004/076041). Such grafting agents lead to a surface layer of hydrophobic molecules on the surface and in the porous structure of a mesoporous ceramic membrane (Alami-Younssi, J. Membr. Sci. 1998, 27-36). The pore size is thus largely determined by the parent ceramic membrane. The long-term stability of such surface grafts under process conditions is not proven. In general, the stability in the presence of water and/or acids is believed to be low, because of hydrolysis of the metal-oxygen-silicon bond linking the graft to the metal oxide surface.

In organophilic pervaporation, the membrane selectively separates the organic component from an aqueous mixture, or selectively permeates an apolar from a more polar component from a solvent mixture. Pervaporation is the selective evaporation of one component of a liquid mixture by using a membrane. The feed is thus in the liquid state while the permeate is a vapour. Alternatively the membrane is operated in vapour permeation mode and both the feed and permeate are present as a vapour. In both cases, the permeate side of the membrane is generally operated at a lower pressure than the retentate or the feed side and preferably operates under sub-atmospheric conditions.

Selective evaporation of one component from a liquid mixture by pervaporation is useful, for example, for the recovery of alcohols from fermentation reactors. An overview of fermentation processes and their related separation processes is given by Lee et al. (Biotechnol. & Bioeng. 2008, 101(2), 209-228). The coupling of organophilic pervaporation membranes directly to fermentation systems has been proposed, but is not a commercially feasible concept yet (Vane, Biofuels, Bioprod. Bioref 2008, 2, 553-588). This is due to the lack of suitable membrane performance. Suitable membranes combine selectivity for the organic component with a tolerance for high water concentrations. As an example, fermentation streams can yield ethanol or n-butanol as main product, depending on the type of bacteria used (EP 0195094 (A1)). In a conventional process, the stream containing water and organics is sent to a distillation column as a first step in the purification process (Vane, ibid.; Luyben, Energy & Fuels 2008, 22(6), 4249-4258). The stream is distilled up to a higher concentration of n-butanol (20-60 wt %) or ethanol (80-96 wt %), respectively. A more energy efficient process route would be to use an organophilic pervaporation membrane for this first concentration step.

The benchmark membrane materials for organophilic pervaporation are PDMS (polydimethylsiloxane) and PTMSP (poly(1-trimethylsilyl-1-propyne)), either in supported or in unsupported form (Vane, ibid.). Membranes based on PDMS have separation factors for ethanol from water ranging from 4-11, and for n-butanol from water ranging from 40 to 60. Because of the thickness of PDMS membranes, in general thin-film ceramic membranes exceed their fluxes by far. PDMS composite membranes containing MFI-type zeolites potentially have higher separation factors than pure PDMS or PTMSP membranes. However, such membranes show irreversible lowering of the flux and separation factor, effectively lowering the membrane performance. This is ascribed to competitive adsorption of acetic acid, eventually leading to degradation of the membrane material (Bowen J. Membr. Sci. 2007, 298, 117-125). Membranes based on the MFI-type zeolite material silicalite-1 were investigated as well. Such membranes have the advantage of higher fluxes, but suffer from the same degradation mechanism as the zeolite composite membranes described above. In addition, the large scale production of highly selective silicalite membranes is not feasible yet. This is mainly due to defects that occur in the larger surface areas of commercial scale membranes, and that were not present in the best research samples. All PDMS, PTMSP, or related composite membrane materials suffer from swelling in organic solvents. As a direct effect, the separation performance is determined by the degree of swelling in the specific medium.

Recent investigations have shown that organic-inorganic hybrid silica membranes based on the precursors 1,2-bis(triethoxysilyl)ethane (BTESE) and methyl-triethoxysilane (MTES) are suitable for the separation of water from several organic solvents, including n-butanol (Castricum et al., Chem. Commun. 2008, 1103-1105; J. Mater. Chem. 2008, 18, 1-10, Sah et al., WO 2007/081212). The long-term stability of these membranes was unprecedented. Membrane life-times up to at least two years were demonstrated at an operating temperature of 150° C. In addition, this membrane material resists the presence of organic and inorganic acids as minor component, ranging up to 1.5 wt % of acetic acid in a mixture of ethanol/water in a ratio of 19:1 (Kreiter, Chem. Sus. Chem. 2009, 2, 158-160; WO 2010/008283). The organic-inorganic hybrid silica membrane material consist of an amorphous 3-D network structure, which intrinsically resists swelling. As a consequence, the organic medium in which the membrane is applied does not alter its performance over time. Importantly, although these membranes are stable in aggressive organic solvents, their application in organic nanofiltration or in organophilic pervaporation, in which the organic solvent is the permeating component, is unfeasible. This is due to the relatively polar pore structure of these membranes, probably because of the presence of large numbers of hydroxyl groups in the micropores. Because of this polarity, the permeance of organic components through these membranes is very low compared to their water permeance. Intrinsically, the membranes disclosed in WO 2007/081212 are therefore selective for water over organics.

### DESCRIPTION OF THE INVENTION

The present invention provides hybrid membranes having increased organo-philicity compared to prior art organic-inorganic hybrid membranes. These new membranes enhance the permeance of organic solvents. The membranes are capable of selectively retaining a relatively hydrophilic molecule from a mixture of a relatively hydrophobic molecule and the relatively hydrophilic molecule. It was found according to the invention that increasing the length of the bridging organic group or the terminal (monovalent) organic group in the organic-inorganic hybrid structure leads to a dramatic increase in hydrophobicity and thus higher selectivity, and surprisingly also provides higher fluxes.

The relatively hydrophilic molecule which can be selectively retained by the membranes of the invention is typically water. Other examples include small highly polar organic solvents, especially methanol, and carbon dioxide, ammonia and the like. The relatively hydrophobic molecule component which selectively permeates the membrane has a lower hydrophilicity (or polarity) than the retained molecule, which in individual cases may be water or methanol or another polar molecule. Such relatively hydrophobic molecules can be a higher alcohol, or another organic molecule. In the membranes of the present invention, the larger component (the organic) in the mixture is permeating preferentially, as long as it is more hydrophobic (or less polar) than the smaller component, and up to a maximum size of about 200 Da. The separation mechanism of these membranes is thus based on affinity rather than size.

The membranes of the invention, i.e. the membrane layers, are based on silica, wherein at least 10%, preferably at least 25% and more preferably at least 40% of the silicon atoms has a monovalent C₁-C₃₀ organic (in particular hydrocarbyl or fluoro-hydrocarbyl) substituent and/or a divalent C₁-C₁₂ organic (in particular hydrocarbylene) substituent, wherein the average number of carbon atoms in the monovalent organic groups and the divalent organic groups taken together is at least 3.5. Typically, at least one of said monovalent and divalent groups contains at least 6 carbon atoms.

In particular, the membranes comprise terminal monovalent organosilane groups of the formula

≡O₁₅Si—R [I],

wherein R is a C₁-C₃₀ organic group which may be substituted by fluorine atoms, and/or bridging divalent organosilane groups of one of the formulas:

≡O_{1.5}Si—CₓH_{2(x-y)}—SiO_{1.5}≡ [II],

≡O_{1.5}Si—CₓH_{2(x-y)}—Si(CH₃)O_{1.0}═ [III] or

═O_{1.0}Si(CH₃)—CₓH_{2(x-y)}—Si(CH₃)O_{1.0}═ [IV],

wherein x=1-12, preferably 6-12 and y<x and y=0-8. When, in a less preferred embodiment, only monovalent groups of formula [I] are present, i.e. no divalent groups are present, then R is a C₆-C₃₀ organic (hydrocarbyl) group which may be substituted by fluorine atoms. When only divalent groups of formula [II], [III] or [IV] are present, i.e. no monovalent groups of formula [I] are present, then x has a value of at least 6, for example 6-12 (i.e. the bridging group is a C₆-C₁₂ hydrocarbylene group), preferably at least 8.

For membranes containing groups of formula [I], in particular, at least 25%, more preferably at least 30% of the silicon atoms in the silica is substituted with a C₁-C₃₀ organic (hydrocarbyl or fluorohydrocarbyl) group R of formula [I]. The number 1.5 after the oxygen (O) atom in formula [I] means that on each Si atom on average about 1.5 oxygen atom is present in the organosilane groups of formula [I]. The symbol ≡ represents the three remaining bonds each connecting the silicon atom with a next silicon atom of the silica structure through an oxygen atom.

As used herein, a hydrocarbyl group or a hydrocarbylene group is an organic group containing carbon and hydrogen atoms. Those groups may be linear, branched and/or cyclic, and they may saturated or unsaturated or even aromatic. However a hydrocarbyl group containing a heteroatom such as oxygen, sulphur of nitrogen which does not carry a hydrogen atom, is still considered to be a hydrocarbyl group for the purpose of this invention, in particular for the monovalent organic groups. Thus hydrocarbyl and organic are used interchangeably and may contain heteroatoms, in the chains or cyclic structures. The monovalent hydrocarbyl group can be any alkyl, alkenyl, alkynyl, cycloalkyl or aryl group or combined group. Examples include methyl, ethyl, etc. pentyl, or hexyl, hexyloxyethyl, octyl, dodecyl, phenyl, naphthyl, benzyl, 2-pyridylmethyl, carbazol-9-yl-ethyl, p-octylphenyl etc. Similarly, the divalent hydrocarbyl group can be any alkylene, alkenylene, alkynylene, cycloalkylene or arylene group or combined group. Examples thereof include methylene, ethylene, hexylene, decylene, phenylene, biphenylene etc.

The hydrocarbyl groups may be substituted with any number of fluorine atoms, up to full substitution, i.e. perfluoroalkyl groups. Especially useful are hydro-carbyl groups which contain perfluoroalkyl-ethyl groups such as 3,3,4,4,5,5,6,6,6-nona-fluorohexyl or 3,3,4,4,5,5,6,6,7,7,8,8,8-tridecafluorooctyl (=1,1,2,2-tetrahydro-perfluorooctyl). Further examples of fluorinated hydrocarbyl groups include, perfluoro-hexyl, p-fluorophenyl, perfluorophenyl, p-(trifluoromethyl)phenyl, p-(perfluorohexyl)-phenyl, and 3,4,5-tris(nonafluorohexyl)phenyl.

R is preferably a C₇-C₂₄ alkyl or aralkyl group, most preferably a C₈-C₁₈ alkyl group. It may be branched, such as in 1-methylpentyl, 2-ethylhexyl (isooctyl), 3,7-dimethyloctyl, p-tolyl, and the like. The hydrocarbylalkyl group may contain double bonds and/or cyclic groups, such as in oct-3-enyl, or cyclohexylmethyl, or phenylethyl, but the preferred hydrocarbyl group is saturated and acyclic. The preferred alkyl group is a linear alkyl group such as n-hexyl, n-heptyl, n-octyl, n-nonyl, n-decyl, n-dodecyl, n-octadecyl etc., or fluorinated analogues.

The membranes of the invention typically comprise bridging (divalent) organosilane moieties of the formula [II], or [III] or [IV]: In this way, couples of silicon atoms are bridged by a C₁-C₁₂ hydrocarbylene group, preferably a C₂-C₁₂ hydro-carbylene group, or preferably a C₆-C₁₂ hydrocarbylene group in case no monovalent group is present. The proportion of the total silica content of the membrane may be such that at least 10%, preferably at least 20%, typically at least 25%, in particular at least 30%, up to 70%, or up to 80%, or up to 90% or even up to 100% of the silicon atoms of the membrane layer is part of a bridging group of formula II or III or IV.

As in formula [I], the numbers 1.5 and 1.0 after the oxygen atoms in formulas [II], [III] and [IV] mean that on each Si atom on average about 1.5 or 1.0 oxygen atom is present in the bridging groups of formulas [II], [III] and [IV], respectively. Thus, on average, each silicon atom is connected to one organic group and to three oxygen atoms in formula [II], and to two organic groups and two oxygen atoms in formula [IV]; each oxygen atom is connected to two silicon atoms in the bulk of the material.

The hydrocarbylene group represented by CₓH_{2(x-y)} can be a linear or branched, or even cyclic, unsubstituted or (fluorine-)substituted alkylene or arylene fragment. It may be partly unsaturated, wherein y represents the number of unsaturations, but preferably y=0 or 1 (saturated or mono-unsaturated), especially 0 (saturated alkylene groups). Preferably, the alkylene groups in the bridging moiety of formulas [II], [III] and [IV] are unbranched.

In a less preferred embodiment of the invention, the membranes comprise only monovalent organic groups according to formula I. In order to achieve a minimum hydrophobicity and a sufficient flux, the alkyl groups R should then have a minimum length of 6, preferably at least 7, more preferably at least 8, most preferably at least 9 carbon atoms. Also, the minimum proportion of monovalent hydrocarbyl groups (=proportion of silicon atoms bound to a hydrocarbyl group) is 25 mole % on the basis of the total number of silicon atoms. Preferably, at least 50%, more preferably at least 75% , of the silicon atoms in the silica is substituted with a C₆-C₂₄, especially C₈-C₁₈ hydrocarbyl or fluorohydrocarbyl group. Any remaining silicon atoms may be linked by only oxygen in this embodiment.

In another, preferred embodiment of the invention, the membranes comprise only divalent (bridging) organic groups according to formula [II], [III] or [IV]. In order to achieve a minimum hydrophobicity and a sufficient flux, the bridging hydro-carbylene groups should then have a minimum length of 6, preferably at least 8 carbon atoms. Also, the preferred minimum proportion of silicon atoms bound to a hydro-carbylene group is 50 mole % on the basis of the total number of silicon atoms. Preferably, at least 65%, more preferably at least 80%, or even essentially all of the silicon atoms in the silica are bridged with another silicon atom through the C₆-C₁₂ hydrocarbylene group. Any remaining silicon atoms may be linked by only oxygen in this embodiment.

In an especially preferred embodiment of the invention, the membranes comprise both monovalent groups of formula [I], and divalent groups of formula [II] or [III] or [IV]. In this embodiment, either the monovalent groups [I] should have a minimum length of 6 carbon atoms, or the divalent groups [II], [III] or [IV] should have minimum length of 5 carbon atoms or both. It is preferred that either the monovalent organic group has a minimum length of 6 carbon atoms, or the divalent hydrocarbylene group has a minimum length of 6 carbon atoms (for saturated or mono-unsaturated divalent groups) or preferably 8 carbon atoms, or both.

Alternatively and advantageously, the average number of carbon atoms of monovalent organic groups and divalent organic groups should be at least 3.5, preferably at least 4, more preferably at least 4.5, most preferably at least 5 carbon atoms, up to e.g. 16, preferably up to 14, most preferably up to 12 carbon atoms. For calculating the average number of carbon atoms, the molar proportions of the various groups are multiplied by their carbon atom number and averaged. Herein, any silicon atoms not linked to an organic group are taken into account in this calculation as a group having 0 carbon atoms. As an example, a silica layer having equimolar amounts of (monovalent) butyl groups (4 carbon atoms) and (bridging) ethylene groups (2 carbon atoms) would have an average of 3.0 carbon atoms, and would not meet the requirement of the invention. On the other hand, a 3:1 combination of butyl and ethylene groups would have an average of 3.5, just meeting the minimum requirement, although not the more preferred minimum level. As a further example, an equimolar amount of bridging hexylene groups (6 carbon atoms) and silicon atoms not substituted with organic groups would have an average of 3.0 carbon atoms, thus not fulfilling the requirement, while such a combination in a ratio of 3:2 would result in an average of 3.6 and thus meet the minimum requirement. Again, any remaining silicon atoms may be linked by only oxygen in this embodiment.

Specific embodiments of the invention following from the above preferences include silica-based membrane layers having:
only divalent alkylene groups having at least 6 carbon atoms, at least 50%, at least 65%, or at least 80%, of the silicon atoms being substituted with bridging divalent groups;
only divalent groups (alkylene, cycloalkylene, arylene or other) having at least 8 carbon atoms, at least 40%, at least 50%, etc. of the silicon atoms being substituted with bridging divalent groups;
divalent alkylene groups having at least 6 carbon atoms, and monovalent groups having any length (at least methyl), at least 40% of the silicon atoms being substituted with divalent groups and at least 10%, at least 25%, etc. of the silicon atoms being substituted with monovalent groups;
divalent groups (alkylene, cycloalkylene, arylene or other) having at least 8 carbon atoms, and monovalent groups having any length (at least methyl), at least 25% of the silicon atoms being substituted with divalent groups and at least 10%, at least 25%, etc. of the silicon atoms being substituted with monovalent groups,
divalent groups of having at least 6 carbon atoms, and monovalent groups having at least 6 carbon atoms,
divalent groups of having any length, and monovalent groups having at least 6 carbon atoms, at least 10%, at least 25% etc. of the silicon atoms being substituted with divalent groups and at least 25%, at least 40%, at least 50% etc. of the silicon atoms being substituted with monovalent groups;
   in each embodiment, the total minimum degree of substitution of the silicon atoms being substituted with divalent or monovalent groups depends on the lengths and proportions of the various groups so as to arrive at the minimum average number of carbon atoms as defined above.

In the group with formula [I], with R═CₚH_{2(p-q)-r+1}Fᵣ, the carbon number is p, and in the groups with formulas [II], [III] and [IV] the carbon number is x, x+1 and x+2, respectively. Should any proportion of tetraoxysilane groups (silicon only bond to oxygen) be present, their carbon number is zero, and likewise, if any amount of a group having the formula ═Si(CH₃)CₚH_{2(p-q)-r+1}Fᵣ (an alternative to formula [I]) be present, its carbon number is p+1. For example, in an equimolar proportion of groups [I] and [II], with a bis-silyl-ethane (x=2) as [II], the minimum length for R in [I] is C₅ (pentyl, p=5), preferably C₆ (hexyl) or higher. Similarly, for a bis-silyl-butane (x=4), the minimum length for R is C₃ (propyl, p=3) etc.

The molar ratio of the monovalent and divalent (bridging) silane moieties in the mixtures of this embodiment is preferably between 1:9 and 18:1, more preferably between 1:9 and 3:1. Ratios between 1:4 and 9:1, preferably between 1:2 and 9:1, especially between 1:1 and 3:1 are also preferred embodiments. As the bridging moieties contain two silicon atoms each, the preferred molar ratio between silicon atoms bound to monovalent hydrocarbyl groups and silicon atoms bound to divalent hydrocarbylene groups is preferably between 1:18 and 9:1, more preferably between 1:18 and 3:2, while such ratios between 1:8 and 4.5:1, preferably between 1:4 and 4.5:1, especially between 1:2 and 1.5:1 are also preferred. Again, the minimum proportion of silicon atoms bound to either an hydrocarbyl group or an hydrocarbylene group is 25 mole % on the basis of the total number of silicon atoms. Preferably, at least 40%, more preferably at least 50%, even more preferably at least 65%, more preferably at least 80%, most preferably at least 90% of the silicon atoms in the silica are bound to either an hydrocarbyl group or a bridging hydrocarbylene group. Any remaining silicon atoms may be linked by only oxygen in this embodiment.

The membranes or molecular separation membrane layers of the invention are of an amorphous material with a disordered array (as distinct from a long range periodic array) of micropores. One way of assessing the disordered nature of these structures is to use one of several diffraction techniques using e.g. electrons, x-rays and neutrons.

In contrast to the organic-inorganic membranes in the state of the art (Castricum et al., Chem. Commun. 2008, 1103-1105; J. Mater. Chem. 2008, 18, 1-10, Sah et al., WO 2007/081212), the pore sizes of the membranes of the current invention could not be determined using permporometry (Tsuru et al., J. Membr. Sci. 2001, 186, 257-265 or Huang et al. J. Membr. Sci. 1996, 116, 301-305, or Deckman, US patent application 2003/0005750) using water as condensable gas and helium as permeating gas. For the membranes of the current invention no decrease of the helium permeance was observed upon increase of the partial water vapour pressure. This indicates that water does not condense in the pores of these membranes and thus the pores are not blocked by water vapour. In addition, nitrogen adsorption measurements according to the method of BET (Brunauer, Emmett, and Teller) show low or even absent surface areas. From this, it is concluded that no mesopores are present in the membranes of the current invention.

The membrane layers may be referred to as microporous. The porosity of the membranes is typically below 45%, e.g. between 10 and 40%, which is also indicative of a disordered array, since ordered arrays (e.g. zeolite crystals) usually have porosities above 50%. The microporous layer of the membrane has an average pore diameter between 0.4 and 2.0 nm, preferably between 0.5 and 1.3 nm.

As a measure of the membrane performance in nanofiltration, the molecular weight cut-off value (MWCO) is used (Van de Bruggen, J. Membr. Sci. 1999, 156, 29-41; Toh, J. Membr. Sci. 2007, 291, 120-125). The MWCO is defined as the rejection of solutes versus their molecular weight. The molecular weight corresponding to 90% rejection of the solute is taken as the MWCO. As typical solutes for the determination of MWCO values are taken polymer oligomers, such as polyethyleneglycol and polystyrene, or dye molecules. Some molecular weight of common dye molecules are given below, expressed in Da.

TABLE 1
Common dye molecules and their molecular weights in Da.

| Dye | Molecular weight (Da) |
|---|---|
| Neutral red | 288.77 |
| Methyl orange | 327.33 |
| Solvent blue 35 | 350.46 |
| Sudan IV | 380.45 |
| Sudan black | 456.54 |
| Patent blue | 543.68 |
| Congo red | 696.68 |
| Bengal rose | 973.67 |

The membranes of the current invention can be characterized by MWCO determination using dye molecules or other suitable markers. The compositions defined under the formulae I-IV lead to membranes with distinct MWCO domains. More specifically, the membranes can be characterized as having MWCO values between 200 and 2000 Da. Especially, the membranes of the invention can have a cut-off value of 200-1000 Da, in particular, a cut-off value of 300-800 Da. Depending on the intended uses, the membranes can have different cut-off values, such as 200-400 Da (for separating small molecules, exemplified and if necessary tested with Solvent Blue 35 or Sudan IV), 400-600 Da (for separating medium-sized molecules exemplified and if necessary tested with Patent Blue), or 600-800 Da (for separating larger molecules exemplified and if necessary tested with Congo Red). The solvent of the MWCO determination plays a significant role in the observed value. This is caused by solvent-solute interactions and membrane-solvent interactions.

The membranes (or microporous membrane layers) can have a thickness between 20 and 2000 nm, and are preferably supported, e.g. on a mesoporous (pore diameter between 2.0 and 50 nm) layer of ceramic material that has preferably been deposited on a macroporous support (pore diameter larger than 50 nm). This meso-porous layer can comprise materials such as gamma-alumina, titania, zirconia, organic-inorganic hybrid silica, and mixtures of these.

The membranes of the invention can be produced by a process as described e.g. in WO 2007/081212. In brief, such a process comprises:
(a) hydrolysing a silicon alkoxide having the formulas

(R′O)₃Si—R [Ia],

or a silicon alkoxide having one of the formulas

(R′O)₃Si—CₓH_{2(x-y)}—Si(OR′)₃ [IIa]

(R′O)₃Si—CₓH_{2(x-y)}—Si(CH₃)(OR′)₂ [IIIa],

(R′O)₂(CH₃)Si—CₓH_{2(x-y)}—Si(CH₃)(OR′)₂ [IVa],

or a mixture of silicon alkoxides having the formulas [Ia] and [IIa], [Ia] and [IIIa] or [Ia] and [IVa],

wherein R′ is C₁-C₆ alkyl, especially C₁-C₄ alkyl, preferably methyl or ethyl,

and R, x, and y are as defined above, in an organic solvent to produce a sol of modified silicon or mixed-metal (hydr)oxide;
(b) precipitating modified silicon or mixed-metal (hydr)oxide from said sol onto a mesoporous support;
(c) drying the precipitate and calcining at a temperature between 100 and 500° C., preferably between 200 and 400° C.

In case of a mixture, the molar ratio of the monovalent and divalent silicon alkoxides having the formulas [Ia] and [IIa]/[IIIa]/[IVa], respectively, is typically the same as the ratio of the various groups in the membrane as produced, preferably between 1:9 and 3:1, or alternatively, between 1:4 and 9:1, more preferably between 1:1 and 3:1. In case the membrane to be prepared also has silicon bound to oxygen only, an appropriate amount of a tetra-alkoxysilane of the formula (R′O)₄Si is hydrolysed as well, for example in a molar ratio of organo-silane (monovalent and divalent taken together) to tetra-alkoxysilane between 1:1 and 1:0. The precursor alkoxides to be used in the processes of the invention are either commercially available or can be produced from commercially available starting materials.

The hydrolysis is carried out in an organic solvent such as ethers, alcohols ketones, amides etc. Alcohols related to the alkoxide groups of the precursors, such as methanol, ethanol, and propanol, are the preferred solvents. The organic solvent can be used in a molar amount of e.g. 4 to 40 per mole of silane precursors, preferably from 6 to 30 moles per mole. Alternatively, the weight ratio between organic solvent and silane precursor can be between 1:1 and 1:10, more preferably between 1:2 and 1:3. The hydrolysis is carried out in the presence of water and, if necessary, a catalyst, preferably an acid catalyst. The amount of water to be used depends on the hydrolysis rate of the particular silicon or metal alkoxides and the volume ratio of water to organic solvent can vary from e.g. 1:99 to 25:75, preferably from 2:98 to 15:85. The preferred molar ratio of water to silicon is between 1 and 8, more preferred between 2 and 6.

The drying and/or calcination of the precipitate is carried out as described in WO 2007/081212, preferably under an inert, i.e. non-oxidising atmosphere, for example under argon or nitrogen. The calcination temperature is at least 100° C., up to about 600° C., preferably between 200 and 400° C., using a commonly applied heating and cooling program.

The membranes according to the invention can be used in nanofiltration, for separating relatively large organic molecules, such a dyes, catalysts, solid impurities and macromolecules, having more than 12 carbon atoms or having a molar weight above 200 Da from organic solvents having 1-12 carbon atoms or having a molar weight below 180 Da, such as alkanes, benzene, toluene, xylenes, dichloromethane, alkyl and aryl alcohols, tetrahydrofuran, N-methylpyrrolidone, dimethylformamide, and similar solvents or mixtures of these. The components having a molecular weight above 200 Da can also be separated from solvents under supercritical conditions such as CO₂, acetone, methane, ethane, methanol, ethanol and the like. In all of these cases, the continuous medium (the solvent not being water) passes the membrane, whereas the component with molecular weight above 200 Da is retained by the membrane. Examples of such dyes, catalysts, impurities and other macromolecules include
1. Organometallic or coordination complexes, such as ferrocene, iron(III) acetyl-acetonate, iron(III) naphthenate, copper(II) naphthenate, Wilkinson's complex, Ru-BINAP, Rh-DUPHOS, dendrimer catalysts, Co- or Mg-Salen, metal porphyrin complexes, polyoxometalates, or related compounds.
2. Metal nanoparticles and their oxides or metal droplets, such as iron, copper, palladium, platinum, or gold nanoparticles, or mercury droplets.
3. Polynuclear aromatics (PNAs), such as anthracene, phenanthrene, coronene, pyrene, rubrene, 9,10-diphenylanthracene, and similar compounds
4. Naturally occurring compounds, such as phospholipids, free fatty acids (FFA), pigments, sterols, carbohydrates, proteins, carotenoids, amino acids, squalene, or flavouring chemicals.
5. Impurities in (crude) oil, such as longer aliphatic components commonly called waxes, polymeric components like isoprenes in hydrocarbon streams, alkyl-aromatics, organic acids like naphthenic acid, and related components.
6. Active pharmaceutical ingredients, such as 6-aminopenicillanic acid, spiramycin, or rapamycin.
7. Dye molecules, such as Sudan black, Sudan blue, Sudan III, Sudan IV, Bengal Rose, Brilliant blue, or methyl orange.

The membranes of the invention can also be used in organophilic per-vaporation the separation of organic molecules, such as alkanes, benzene, toluene, xylenes, dichloromethane, alkyl and aryl alcohols, tetrahydrofuran, N-methyl-pyrrolidone, dimethylformamide, and similar compounds from aqueous mixtures. In such a separation, the hydrophobic, organic component passes through the membrane, contrary to the process of WO 2007/081212 in which water preferentially passes the membrane. WO 2007/081212 describes pervaporation membranes that preferentially permeate the component with the lowest molecular size, i.e. water is permeating, whilst retaining the larger, organic component. The effective separation mechanism of such membranes thus is molecular sieving. In contrast, in the membranes of the present invention, the largest component (the organic) in the mixture is permeating preferentially, up to a molar weight of up to about 200 Da. The separation mechanism of these membranes in organophilic pervaporation is thus based on affinity for the organic medium rather than size.

In the separation of water as minor component from organics as major component in the feed mixture, the separation factor, α_{w}, is defined as:

$${α}_{w} = \frac{{Y}_{w} / {Y}_{o}}{{X}_{w} / {X}_{o}} \qquad ( 1 )$$

Where Y and X are the weight fractions of water (w) and organic (o) in the permeate (Y) and feed (X) solutions, respectively.
In the separation of organic as minor component from water as major component in the feed mixture, the separation factor, αₒ, is defined as:

$${α}_{o} = \frac{{Y}_{o} / {Y}_{w}}{{X}_{o} / {X}_{w}} \qquad ( 2 )$$

Where Y and X are the weight fractions of water (w) and organic (O) in the permeate (Y) and feed (X) solutions, respectively.

When the membrane of the invention is used for separating alcohols from alcohol/water mixtures, i.e. for upgrading alcohol streams, e.g. to fuel grade, the input stream can have alcohol concentrations between e.g. 1 and 40%, and the output stream can have alcohol concentrations which are higher than the input stream and are between e.g. 20 and 80%.

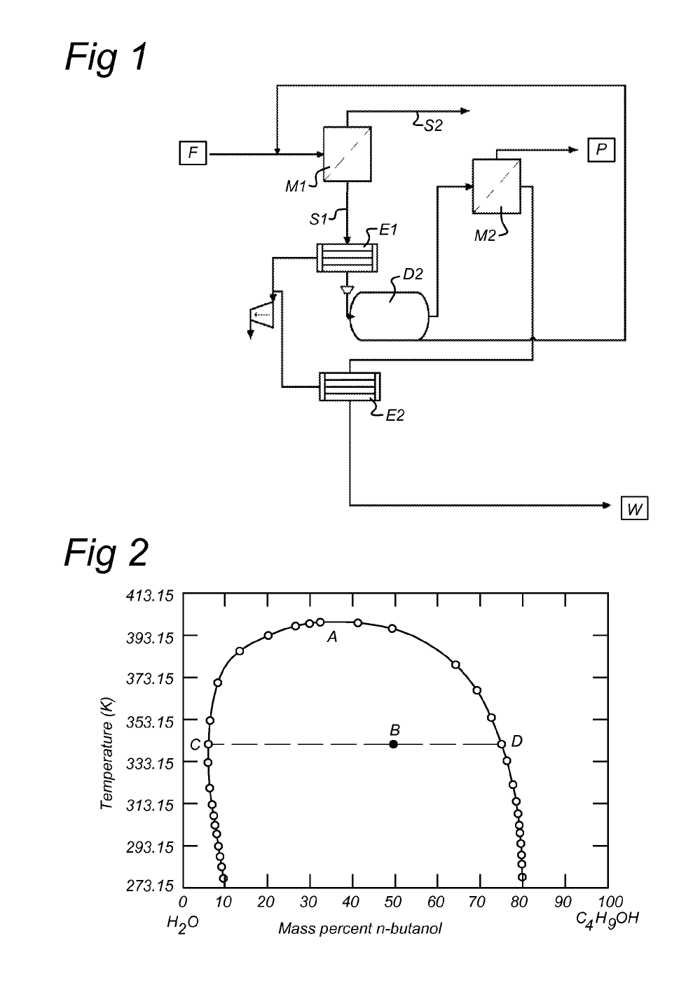

A particularly advantageous application of the membranes of the invention is in the recovery of alcohols from fermentation broths, using pervaporation. Such use of another type of organophilic membranes is disclosed in U.S. Pat. No. 5,755,967 (A), US 2009/-114594 and Vane (J. Chem. Technol. Biotechnol. 2005, 80, 603-629). An example of this process concept is represented schematically in FIG. 1, showing n-butanol-water separation using pervaporation. Therein, a stream containing n-butanol and water in a homogenous phase (water concentration of 90-99%) is sent from the fermentor F to an organophilic pervaporation membrane M1 according to the present invention. This membrane produces two streams S1 and S2. S2 will contain no more than 0.5 wt % butanol, preferably less than 0.1 wt % and 51 will contain approximately 20-50% butanol. S1 is produced under vacuum so before being fed to the decanter D2, the vacuum is broken in pressure equilibrator E1. In decanter D2 n-butanol and water will spontaneously separate to generate a two phase mixture. The top phase will contain around 80 wt % n-butanol whereas the bottom phase contains around 3-8 wt % butanol in water. The relative size of these phases depends on the decanter feed concentration; the higher the n-butanol concentration, the larger the size of the top phase. When higher butanol purities are required, the top phase is sent to a dehydration membrane M2, which can be an organic-inorganic dehydration membrane according to WO 2007/-081212. This membrane removes water from the n-butanol stream until fuel grade is reached and collected in product exit P. The permeate stream from membrane M2 is a water stream containing less than 5 wt % n-butanol, preferably less than 1 wt %, and optionally is returned to before membrane Ml (not shown), and/or to a second equilibrator E2, and ultimately to a waste water exit W. The bottom phase from D2 is returned to before the first membrane Ml so that the remaining n-butanol can be recovered.

The butanol feed can optionally be taken from an ABE (acetone-butanol-ethanol) production process, either after acetone and ethanol removal or at some point before their removal. Other butanol isomers may be developed in the fermentor. These variations are taken into account in the process boundaries described above. In this process, D2 can optionally be operated under vacuum and waste water may be recycled if it contains enough product.

The phase diagram for n-butanol is given in FIG. 2; obtained from Rochester Institute of Technology, One Lomb Memorial Drive, Rochester, N.Y. 14623-5603. The curve delimits the single-phase region (outside the curve) from the two-phase region (below the curve). At a given temperature (represented by the line C-D) the mixture will separate into two phases as long as the composition of the mixture is within the phase envelope. As an example, a 50 mass % mixture represented by point B will separate in two phases with compositions corresponding to point C (water-rich) and point D (alcohol-rich). Any mixture represented by a point on the dotted line C-D will phase separate into a top layer with composition D and a bottom layer with composition C. The critical solution temperature for the n-butanol/water system is 126° C. (399.15K). Below this temperature the mixture phase separates, provided the overall composition lies within the phase envelope. In the case of a non-homogeneous feed (e.g. feed water concentration 20-92%, at 70° C.) it will become more advantageous to send the feed directly to the decanter (embodiment not shown). Then the top phase is sent to a dehydration membrane and the bottom phase is sent to an organophilic membrane. The resulting permeate from the latter membrane is sent back to the decanter or to another decanter.

A similar process scheme could be used for ethanol recovery from a fermenter, by replacing the decanter D2 by a distillation column. In this ethanol recovery process, the organophilic pervaporation membrane will strongly reduce the load on the distillation column, thereby lowering the energy needed for the separation process. Alternatively, when the water content of S1 is low enough, it may be advantageous to send this stream directly to the second membrane unit M2 and avoid the use of a distillation column.

The invention also pertains to a production facility for producing an alcohol/-water mixture of high alcohol concentration, comprising:

(i) a production unit of a low grade alcohol/water mixture (F in FIG. 1); in fluid connection with:
(ii) a membrane unit comprising one or more membranes of the present invention (M1 in FIG. 1), for increasing the alcohol concentration of the alcohol/water mixture, and optionally:
(iii) one or more further separation units (D2, M2 or other) for separating alcohol from water.
Herein, “high alcohol concentration” may mean at least 80%, in particular at least 90%, or even at least 95% or higher, by weight. On the other hand, a “low grade alcohoU water mixture” may denote a mixture containing less than 20%, in particular less than 10%, down to e.g. 2% or even 1% alcohol.

The invention also concerns a purification facility for purifying alcohol from a low grade alcohol/water mixture, comprising:

(ii) a membrane unit comprising one or more membranes according to the present invention (M1), in fluid connection at the permeate side thereof with:
(iii) one or more further separation units (D2, M2) for separating alcohol from water.

The further separation units (iii) of the production and purification facilities may comprise a decanter unit (D2) in case the alcohol is butanol or a higher alkanol, or a distillation unit (replacing D2) when the alcohol is ethanol or propanol. Instead or in addition, the further separation unit may comprise a membrane unit capable of dehydration by selectively retaining the alcohol (M2). Such a membrane unit (M2) may advantageously comprise on ore more silica-based organic-inorganic membranes, containing short-chain bridges, especially ethylene bridges between pairs of silicon atoms, as described in WO 2007/081212. Such water-permeating membrane unit is preferably located downstream of the decanter or distillation unit.

Thus, the invention also pertains to a separation unit for separating a water-miscible or water-soluble organic molecule such as an alcohol from water, comprising a first silica-based membrane unit as defined herein, comprising divalent and optionally monovalent groups with an average number of carbon atoms of at least 3.5, preferably at least 4.0, and a second silica-based membrane, similarly comprising divalent and optionally monovalent groups but having an average number of carbon atoms of less than 3.5, preferably less than 2.5, the first and the second membrane units being connected with fluid lines and optional further components as illustrated above.

### EXAMPLES

In the Examples below, the following abbreviations are used

| | |
|---|---|
| BTES-2 | 1,2-Bis(TriEthoxySilyl)ethane (=BTESE) |
| BTES-8 | 1,8-Bis(TriEthoxySilyl)octane (=BTESO) |
| R-TES | Alkyl-TriEthoxySilane (alkyl group variable) |
| 1-TES | Methyl-TriEthoxySilane |
| 3-TES | n-Propyl-TriEthoxySilane |
| 6-TES | n-Hexyl-TriEthoxySilane |
| 10-TES | n-Decyl-TriEthoxySilane |

### Example 1

### Production of a Hybrid Organic/Inorganic Silica Sol Based on BTES-2 and R-TES, Method A

The precursors BTES-2 (BTESE, 1,2-bis(triethoxysilyl)ethane, purity 96%, Aldrich), RTES (R-triethoxysilane, R=n-propyl, n-hexyl, n-decyl; purity >95%, ABCR GmbH & Co), and ethanol (p.a. Aldrich) were used as received. The precursors were both dissolved in ethanol. Water was mixed with an acid solution (HNO₃, 65 wt % Aldrich), which was diluted in ethanol. Half of this mixture of acid, water and ethanol was added drop-wise to the precursor mixture. The resulting mixture was heated to 60° C. for 1.5 h. After this time, the mixture was cooled in an ice bath with stirring. The second half of the acid, ethanol and water mixture was added drop-wise to the cold mixture. Subsequently, the mixture was heated to 60° C. for another 1.5 h. The reaction was quenched by cooling the sol in an ice bath.

The molar ratios of the reactants were in the range [H₂O]/([BTES-2]+[R-TES])=3-6, [H⁺]/([BTES2]+[R−TES])=0.02-0.4). The molar ratio of BTESE-2 to R-TES was 1:1. The amount of water stated in these ratios includes the water introduced with the concentrated acid (HNO₃, 65%).

### Example 2

### Production of a Hybrid Organic/Inorganic Silica Sol Based on BTES-2 and R-TES, Method B

The precursors BTES-2, RTES, and ethanol were as in Example 1. The R-TES and the BTES-2 were separately dissolved in ethanol. Water was mixed with an acid solution (HNO₃, 65 wt %, Aldrich), which was diluted in ethanol. A third of this acid, water and ethanol mixture was added drop-wise to the R-TES and ethanol mixture. The resulting mixture was heated to 60° C. for 1.5 h. After this time, the mixture was cooled down in an ice bath, under stirring. The BTES-2/ethanol mixture was added to the R-TES, ethanol, acid and water mixture. Then, the last two third of the acid, ethanol and water mixture was added drop-wise to the cold mixture. Subsequently, the mixture was heated to 60° C. for another 1.5 h. The reaction was quenched by cooling down the sol in an ice bath.

The molar ratios of the reactants were in the range [H₂O]/([BTES-2]+[R-TES])=3-6, [H⁺]/([BTES−2]+[R−TES])=0.02-0.4). The molar ratio of BTESE-2 to R-TES was 1:1. The amount of water stated in these ratios includes the water introduced with the concentrated acid (HNO₃, 65%).

### Example 3

### Production of a Hybrid Organic/Inorganic Silica Sol Based on BTES-8, Method C

Water and nitric acid (HNO₃, 65 wt %, Aldrich) were added to dry ethanol, and the 1,8-bis(triethoxysilyl)octane (BTES-8) precursor was subsequently added to this mixture under vigorous stirring. Immediately, this mixture was placed in a closed glass container in a water bath at 333K, and kept at this temperature for 3 hours under continuous stirring. The reaction was quenched by cooling the sol in an ice bath. The molar ratios of the reactants were in the range [H₂O]/[BTES-8]=3-6, [H⁺]/[BTES-8]=0.02-0.4). The amount of water stated in these ratios includes the water introduced with the concentrated acid (HNO₃, 65%).

### Example 4

### Production of Alumina Supported Hydrophobic Hybrid Silica Membranes Based on BTES-2 and R-triethoxysilanes

Gamma alumina substrate tubes were dip-coated in a clean room with sols produced according to example 1. The example sols were based on the ratios [BTES-2]/[R-TES]/[HNO₃]/[H⁺]=1/1/4/0.1, in which R-TES=3-TES (sol A), 6-TES (sol B), 10-TES (sol C), respectively, and on the divalent precursor BTES-8 (Sol D). Tubular membranes were coated with sol A, B, and C, as described by Campaniello et al. (Chem. Commun., 2004, 834-835) and calcined at 300° C. for 2 h in a N₂ atmosphere with 0.5° C./min as heating and cooling rates. Layer thicknesses obtained for these membranes were in the range of 0.5-1.2 μm.

Gas permeation tests were performed using H₂, N₂, CO₂, and CH₄. Permselectivity numbers were derived from these single gas permeation experiments. The perm-selectivity is defined as the ratio of the permeance of the individual gases, measured in single gas permeation experiments. The following permselectivities for H₂/N₂, H₂/CO₂, and CO₂/CH₄ were observed (Table 2). The decrease in the H₂/N₂ permeance ratio for longer R-TES groups is indicative of an increase of the pore size of the membranes compared to BTES-2. The decrease of the CO₂/CH₄ permeance ratio is related to a decreased affinity for CO₂. This decrease of affinity is indicative for the increase of hydrophobicity of the membranes of the current invention.

TABLE 2
Permeance ratios of gas pairs, derived from
single gas permeance results

| Membrane type | H₂/N₂ | CO₂/CH₄ |
|---|---|---|
| BTES-2 | 15.1 | 4.6 |
| BTES-2 + 1-TES | 9.1 | 2.0 |
| BTES-2 + 3-TES | 7.0 | 2.0 |
| BTES-2 + 6-TES | 3.9 | 1.3 |
| BTES-2 + 10-TES | 3.3 | 1.2 |

### Example 5

### Flux and Separation Factors of n-Butanol/Water Separations

The membranes of the invention were tested in low water concentrations using a water/n-butanol (5/95 wt %) feed mixture at 95° C. (Table 3). With increasing length of the monovalent organic precursor a clear shift to lower selectivity for water is observed. This is caused by a strong increase of the flux of n-butanol The same effect can be observed for a C₈-bridged precursor. A membrane based on a mixture of this precursor with a C₁₀ triethoxysilane, further decreases the water content in the permeate. For the data in Table 2 the definition of a for water as minor component was used (Equation 1). Values of α>1 therefore indicate a membrane that is selective for water and lead to water enrichment in the permeate stream.

TABLE 3
Summary of water/butanol (5/95 wt %) pervaporation measurements

| | Bridging | | | Separation |
|---|---|---|---|---|
| | silane | Monovalent | Water flux | factor |
| Membrane type | fragment | chain | (kg/m² · h) | (α_{w}) |
| BTES-2 | C₂ | None | 3.5 | >1000 |
| BTES-2 + 1-TES | C₂ | C₁ | 2.4 | 844 |
| BTES-2 + 3-TES | C₂ | C₃ | 2.5 | 25 |
| BTES-2 + 6-TES | C₂ | C₆ | 1.9 | 13 |
| BTES-2 + 10-TES | C₂ | C₁₀ | 1.1 | 9 |
| BTES-8 | C₈ | None | 3.2 | 9 |
| BTES-8 + 10-TES | C₈ | C₁₀ | 2.2 | 7 |

Testing these same series of membranes in water/n-butanol (95/5 wt %) showed reversed selectivity for the membranes of the present invention (table 3). The selectivity for water changes to selectivity for n-butanol for the monovalent substituents longer than C₃ and for a bridging organic group of C₃. The BTES-2/10-TES mixed precursor membranes has the highest separation factor. As an indication, this selectivity convert a feed stream containing 5 wt % n-butanol in water to a permeate stream containing 40 wt % of n-butanol. Similar to the measurements with low water concentrations (Table 2) an increase of the flux of n-butanol causes the increase of the selectivity for n-butanol over water. For the data in Table 4 and 5 the definition of a for the alcohol as minor component was used (Equation 2). Values of α>1 therefore indicate a membrane that is selective for the alcohol and leads to alcohol enrichment in the permeate stream.

TABLE 4
Overview of water/n-butanol (95/5 wt %) pervaporation
measurement at 95° C.

| | Bridging | | | |
|---|---|---|---|---|
| | silane | Monovalent | n-Butanol Flux | Separation |
| Material | fragment | chain | (kg · m² · h⁻¹) | factor (αₒ) |
| BTES-2 | C₂ | None | 0.01 | <<1 |
| BTES-2 + 6 TES | C₂ | C₆ | 6.5 | 9.6 |
| BTES-2 + | C₂ | C₁₀ | 4.4 | 12.7 |
| 10-TES | | | | |
| BTES-8 | C₈ | None | 10 | 3.2 |
| BTES-8 + | C₈ | C₁₀ | 17 | 6.5 |
| 10-TES | | | | |

### Example 6

### Flux and Separation Factors of Ethanol/Water Separations

Similar to Example 4, the separation of a mixture of water and ethanol (95/5 wt %) leads to an increase of the ethanol concentration in the permeate (Table 5). As an additional benefit, the membranes of the current invention have very high n-butanol fluxes in organophilic pervaporation. Compared to the water fluxes of BTES-2 membranes of 3.5 kg/m².h (Table 3), the n-butanol flux of a BTES-8/10-TES membrane (Table 4) is at least 4 times higher.

TABLE 5
Overview of water/EtOH (95/5 wt %) pervaporation
measurement at 70° C.

| | Bridging silane | Alkyl | Flux | Separation |
|---|---|---|---|---|
| Material | fragment | chain | (kg · m² · h⁻¹) | factor (αₒ) |
| BTES-2 + 6-TES | C₂ | C₆ | 2.3 | 1.6 |
| BTES-2 + 10-TES | C₂ | C₁₀ | 1.5 | 5.4 |

### Example 7

### Acetone and Toluene Fluxes

Solvent permeation measurements were performed at 9.5 bar feed pressure in a cross flow nanofiltration setup, equipped with a 12 l feed vessel. The temperature was maintained at 20° C. (+/−0.5). Fluxes were determined by measuring the permeate volume in measuring cylinder an determining the permeate mass as additional check. Acetone and toluene fluxes are given in Table 6. Clearly, the solvent permeance increases as an effect of the length of the organic substituent R or the length of the bridging organic fragment.

TABLE 6
Overview of solvent fluxes at 9.5 bar feed pressure

| | Bridging silane | Monovalent | Acetone flux | Toluene flux |
|---|---|---|---|---|
| Material | fragment | chain | (l · m² · h⁻¹) | (l · m² · h⁻¹) |
| BTES-2 + | C₂ | C₆ | 0.1 | Not determined |
| 6 TES | | | | |
| BTES-2 + | C₂ | C₁₀ | 0.3 | Not determined |
| 10-TES | | | | |
| BTES-8 | C₈ | None | 0.8 | 0.4 |
| BTES-8 + | C₈ | C₁₀ | 1.3 | 2 |
| 10-TES | | | | |

1-17. (canceled)

18. A hydrophobic membrane comprising a layer based on silica, wherein
(a) at least 25% of the silicon atoms has a bridging C₁-C₁₂ divalent hydrocarbylene group as a substituent, and optionally further silicon atoms having a monovalent C₁-C₃₀ organic group as a substituent;
(b) either the divalent hydrocarbylene group has a minimum length of 8 carbon atoms, or the monovalent organic group has a minimum length of 6 carbon atoms, or both; and
(c) the average number of carbon atoms in the monovalent organic groups and the divalent hydrocarbylene groups taken together is at least 3.5.

19. The membrane according to claim 18, wherein at least 30% of the silicon atoms has a monovalent C₆-C₂₄.

20. The membrane according to claim 19, wherein at least 30% of the silicon atoms has a a C₈-C₁₈ hydrocarbyl group.

21. The membrane according to claim 18, comprising both of the monovalent and divalent groups.

22. The membrane according to claim 21, wherein the molar ratio of the monovalent groups to the divalent groups is between 9:1 and 1:2.

23. The membrane according to claim 21, wherein the average number of carbon atoms of the monovalent groups and the divalent groups is at least 4.

24. The membrane according to claim 23, wherein the average number of carbon atoms of the monovalent groups and the divalent groups is between 4.5 and 12.

25. The membrane according to claim 18, having a thickness between 20 nm and 2 μm.

26. The membrane according to claim 25, having a thickness between 50 and 500 nm.

27. The membrane according to claim 18, wherein the layer is microporous and has an average pore diameter between 0.4 and 2.0 nm.

28. The membrane according to claim 27, wherein the layer has an average pore diameter between 0.5 and 1.3 nm.

29. The membrane according to claim 18, having a cut-off value of 200-1000 Da.

30. The membrane according to claim 18, having a cut-off value of 200-400 Da.

31. The membrane according to claim 18, having a cut-off value of 400-600 Da.

32. A process of selectively retaining a relatively hydrophilic molecule from a mixture of a relatively hydrophobic component and the relatively hydrophilic molecule, comprising contacting the mixture with a membrane according to claim 18.

33. A production facility for producing an alcohol/water mixture of high alcohol concentration, comprising:
(i) a production unit of a low grade alcohol/water mixture; in fluid connection with:
(ii) a membrane unit comprising one or more membranes according to claim 1, for increasing the alcohol concentration of the alcohol/water mixture, and optionally:
(iii) one or more further separation units for separating alcohol from water.

34. The facility according to claim 33, wherein the alcohol is ethanol or propanol, and (iii) comprises a distillation unit.

35. The facility unit according to claim 33, wherein the alcohol is butanol or a higher alkanol, and (iii) comprises a decanting unit.

36. The facility according to claim 33, wherein the membrane unit (iii) comprises a layer based on silica, wherein at least 25% of the silicon atoms has a bridging C₁-C₁₂ divalent hydrocarbylene group as a substituent, and optionally further silicon atoms may have a monovalent C₁-C₃₀ organic group as a substituent, and the average number of carbon atoms in the monovalent hydrocarbyl groups and the divalent organic groups taken together less than 3.5.

37. A purification facility for purifying alcohol from a low grade alcohol/water mixture, comprising:
(i) membrane unit comprising one or more membranes according to claim , in fluid connection at the permeate side thereof with:
(ii) a further separation unit for separating alcohol from water.
